(19) United States
(12) Patent Application Publication
(10) Pub. No.: US 2013/0088900 A1
(43) Pub. Date: Apr. 11, 2013

(54) ENERGY STORAGE SYSTEM AND CONTROLLING METHOD OF THE SAME

(71) Applicant: Jong-Ho Park, Yongin-si (KR)

(72) Inventor: Jong-Ho Park, Yongin-si (KR)

(21) Appl. No.: 13/562,693

(22) Filed: Jul. 31, 2012

Related U.S. Application Data
(60) Provisional application No. 61/545,388, filed on Oct. 10, 2011.

(51) Int. Cl. H02M 7/44

(52) U.S. Cl. 363/71

(57) ABSTRACT

An energy storage system and a controlling method of the energy storage system are provided. The energy storage system reduces power consumption and increases inverter efficiency by providing a plurality of inverters in parallel and selectively driving ones of the inverters according to a power requirement of the load. The energy storage system supplies an alternating current (AC) power to a load. The energy storage system includes: a battery for supplying a direct current (DC) power; a plurality of inverters for connecting in parallel between the battery and the load to convert the DC power to the AC power; and a controller for selectively driving the inverters in accordance with a power requirement of the load.

### CROSS-REFERENCE TO RELATED APPLICATION

This application claims priority to and the benefit of U.S. Provisional Application No. 61/545,388, filed on Oct. 10, 2011, the entire content of which is incorporated herein by reference.

### BACKGROUND

1. Field

Aspects of embodiments of the present invention relate to an energy storage system.

2. Description of Related Art

As environmental degradation, resource depletion, etc., become problems, there is a greater interest in an energy system for storing power that is capable of efficiently utilizing the stored power. Further, the importance of renewable energy (that uses abundantly supplied natural resources such as solar, wind, tidal, etc., and that does not cause significant pollution during power generation) is increasing.

An energy storage system is a system for connecting the renewable energy, a battery for storing the power, and an existing grid power. Much research and development for the system is being made according to recent environment changes.

### SUMMARY

Aspects of embodiments of the present invention relate to an energy storage system and particularly, to an energy storage system and a controlling method of the energy storage system that uses a plurality of inverters for more efficiently outputting power. An energy storage system that uses only one inverter needs an inverter with a rated capacity sufficient to meet the power requirements of the system. For example, an inverter of a 3-kilowatt (kW) system needs to be able to output up to 3 kW in an unloaded state according to the power consumption of the load. This, however, leads to lower efficiency and to an increase in the electricity used when the system drives smaller loads, such as loads that can be driven by an inverter rated for up to 1 kW of output power.

Further aspects of the present invention provide for an energy storage system and controlling method of the energy storage system that reduce the power consumption of the system and increase the inverter efficiency of the system by providing a plurality of inverters in parallel and selectively driving the inverters according to power requirements of the load.

According to an exemplary embodiment of the present invention, an energy storage system for supplying an alternating current (AC) power to a load is provided. The energy storage system includes: a battery for supplying a direct current (DC) power; a plurality of inverters for connecting in parallel between the battery and the load to convert the DC power to the AC power; and a controller for selectively driving the inverters in accordance with a power requirement of the load.

The energy storage system may further include a corresponding plurality of switches between the inverters and the battery for switchably connecting respective ones of the inverters in parallel to the DC power. The controller may be configured to selectively control respective ones of the switches between the inverters and the battery in accordance with the power requirement of the load.

The controller may include: a load information receiving unit for receiving information regarding the power requirement of the load; and a switch controller for controlling the switches for selecting corresponding ones of the inverters in accordance with the received information.

The controller may be further configured to control a provision of operating power to the selected ones of the inverters.

The energy storage system may further include a power measuring unit for acquiring the power requirement of the load, and supplying the acquired power requirement of the load to the controller.

The energy storage system may further include a power predicting unit for predicting the power requirement of the load.

The controller may be configured to determine which of the inverters to selectively drive by: comparing the power requirement of the load with one or more thresholds; and determining a corresponding subset of the inverters to selectively drive in accordance with the comparing.

Exceeded ones of the one or more thresholds may be smaller than a sum of rated capacities of the corresponding subset of the inverters.

The inverters may have substantially a same rated capacity. The controller may be configured to increase a number of the inverters that are selectively driven in accordance with an increase in the power requirement of the load.

The controller may be further configured to selectively drive a minimum number of the inverters that meets the power requirement of the load.

The inverters may have different rated capacities. The controller may be configured to selectively drive ones of the inverters having a lowest sum of respective rated capacities that meets the power requirement of the load.

The inverters may be bi-directional inverters for converting the AC power from an AC source to the DC power.

According to another exemplary embodiment of the present invention, a method of controlling an energy storage system for supplying an alternating current (AC) power to a load is provided. The energy storage system includes a battery for supplying a direct current (DC) power and a plurality of inverters for connecting in parallel between the battery and the load to convert the DC power to the AC power. The method includes selectively driving the inverters in accordance with a power requirement of the load.

The energy storage system may further include a corresponding plurality of switches between the inverters and the battery for switchably connecting respective ones of the inverters in parallel to the DC power. The selectively driving of the inverters in accordance with the power requirement of the load may include selectively controlling respective ones of the switches between the inverters and the battery in accordance with the power requirement of the load.

The method may further include acquiring the power requirement of the load.

The acquiring of the power requirement of the load may include predicting the power requirement of the load.

The selectively driving of the inverters in accordance with the power requirement of the load may include: comparing the power requirement of the load with one or more thresholds; and determining which of the inverters to selectively drive in accordance with the comparing.

The inverters may have substantially a same rated capacity. The selectively driving of the inverters in accordance with the power requirement of the load may include increasing a number of inverters that are selectively driven in accordance with an increase in the power requirement of the load.

The selectively driving of the inverters in accordance with the power requirement of the load may further include selectively driving a minimum number of the inverters that meets the power requirement of the load.

The inverters may have different rated capacities. The selectively driving of the inverters in accordance with the power requirement of the load may include selectively driving ones of the inverters having a lowest sum of respective rated capacities that meets the power requirement of the load.

According to another embodiment of the present invention, an energy storage system for driving a load is provided. The system includes: a plurality of inverters switchably connected in parallel for converting a DC voltage into an AC voltage to be supplied to the load; and a controller for selectively connecting one or more of the plurality of inverters to the load depending on the power requirements of the load.

The DC voltage may be provided by a battery in the energy storage system or by a power generation system connected to the energy storage system.

The energy storage system may further include a plurality of switches corresponding to the plurality of inverters, each switch being arranged to connect the DC voltage to a respective one of the plurality of inverters. The controller may be arranged to control the plurality of switches.

The energy storage system may further include a power measuring unit for calculating the power consumption of the load and for supplying the calculated value to the controller as the power requirement of the load.

The energy storage system may further include a power predicting unit for predicting the power requirement of the load.

The controller may be arranged to determine which of the inverters should be turned on to provide a power output that meets the power requirement of the load. The controller may be arranged to compare the power requirement of the load with one or more thresholds to determine which of the inverters should be turned on.

The inverters may have substantially equal rated capacity. The controller may be configured to increase the number of inverters as the power requirement of the load increase.

The inverters may have different rated capacities. The controller may be configured to select the inverters for which the sum of the rated capacities is the lowest sum that meets the power requirement of the load.

The controller may include a load information receiving unit for receiving information about the power requirement of the load, and a switch controller for controlling on/off operation of the plurality of switches connected to respective ones of the inverters to select at least one of the plurality of inverters based on the received load information.

The energy storage system may further include a DC link unit connected to the power generation system to maintain the level of a DC voltage provided by the power generation system. The plurality of switches may be connected between the inverters and the DC link unit.

According to another embodiment of the present invention, a method of controlling an energy storage system is provided. The method includes selectively connecting one or more of the plurality of inverters to the load depending on the power requirement of the load.

### BRIEF DESCRIPTION OF THE DRAWINGS

The accompanying drawings, together with the specification, illustrate exemplary embodiments of the present invention and, together with the description, serve to explain aspects and principles of the present invention.

FIG. 1 is a block diagram showing a configuration of an energy storage system according to an exemplary embodiment of the present invention.

FIG. 2 is a block diagram schematically showing a configuration of a controller shown in FIG. 1.

FIG. 3 is a flow chart showing a controlling method of the energy storage system of FIG. 1 according to an exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Further, when an element is referred to as being “connected to” another element, it can be directly connected to the other element or be indirectly connected to the other element with one or more intervening elements interposed therebetween. Hereinafter, like reference numerals refer to like elements.

Hereinafter, exemplary embodiments of the present invention will be described in more detail with reference to the attached drawings. In the description, the term “power requirement” of a load relates to not only the actual power requirement (for instance, the amount of power currently being used), but also predicted, anticipated, calculated, etc., power requirements depending on factors such as historical data, the particular appliances making up the load, known maximum power requirements, etc.

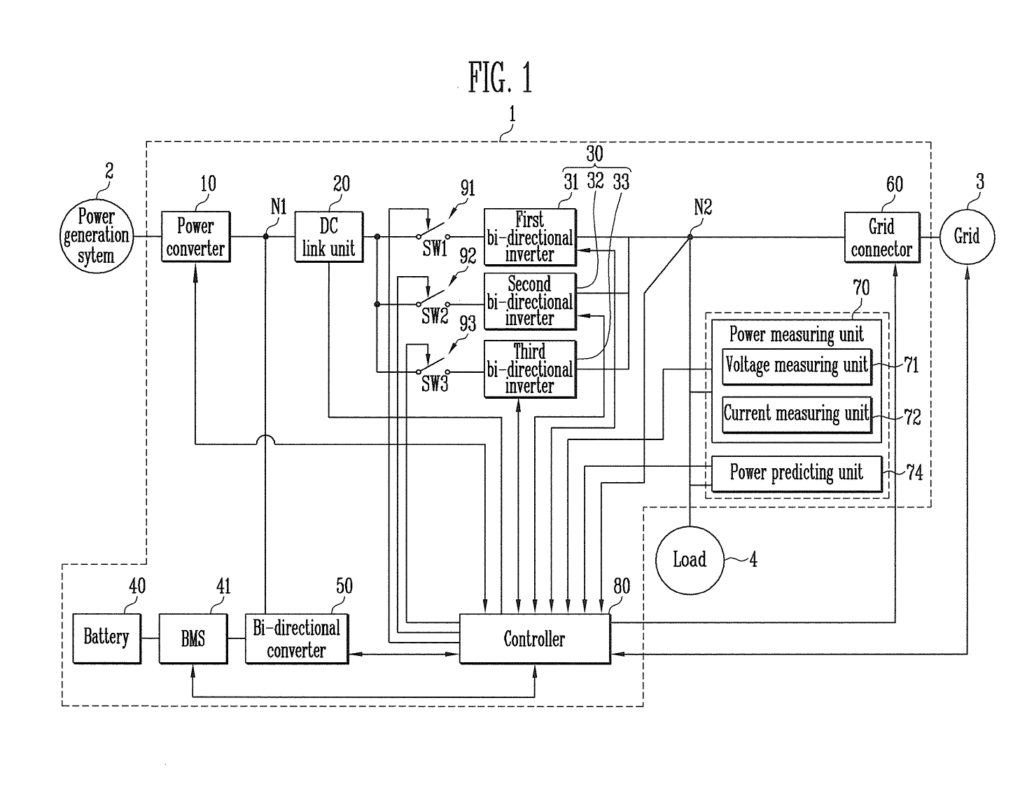

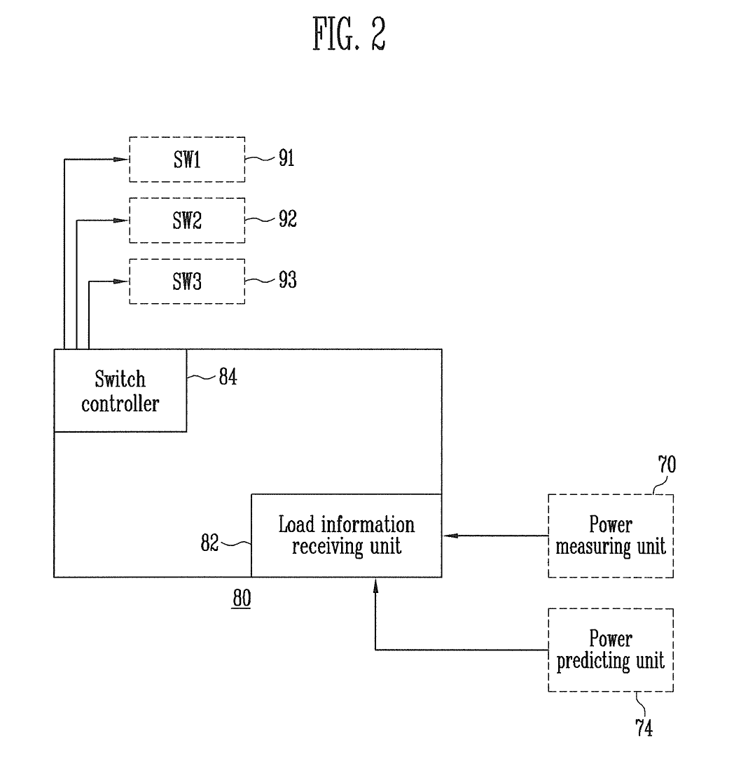

FIG. 1 is a block diagram showing a configuration of an energy storage system 1 according to an exemplary embodiment of the present invention. FIG. 2 is a block diagram schematically showing a configuration of a controller 80 shown in FIG. 1. However, components of each configuration are not limited to those shown. In other embodiments, the components may be varied in various ways that are within the range of one of ordinary skill in the art.

Referring to FIG. 1, the energy storage system 1 is connected to a power generation system 2 and a grid 3 to supply power to a load 4. The power (or energy) generation system 2 is a system producing power using an energy source, such as a renewable energy source. The power generation system 2 supplies the produced power to the energy storage system 1. The power generation system 2 is, for example, a photovoltaic system, a wind power system, or a tidal generation system, and may include the whole power generation system producing the power using renewable energy such as sunlight, wind, tides, solar heat, or geothermal heat.

In particular, solar cells producing electric energy by using solar energy are easy to install in homes or factories and the like and therefore, are suitable for applying to embodiments of the energy storage system 1 configured for individual home use. The power generation system 2 may include a plurality of power generation modules coupled in parallel to form a high-capacity energy system by producing the power in parallel by some or all of the power generation modules.

The grid 3 may include a power plant, a substation, power line, etc. When the grid 3 is in a normal state, the grid 3 supplies the power to the energy storage system 1 or the load 4 and receives the power supplied from the energy storage system 1. When the grid 3 is in abnormal state, power supply from the grid 3 to the energy storage system 1 or the load 4 is stopped, and the power supply from the energy storage system 1 to the grid 3 is also stopped.

The load 4 consumes the power produced from the power generation system 2, the power stored in the battery 40, or the power supplied from the grid 3. For example, the load 4 may be a home, a factory, etc.

The energy storage system 1 stores the power generated by the power generation system 2 into a battery 40 and may transfer the generated power into the grid 3. Further, the energy storage system 1 transfers the power stored in the battery 40 into the grid 3, or may store the power supplied from the grid 3 into the battery 40. Further, the energy storage system 1 may supply the power to the load 4 by performing UPS (uninterruptible power supply) operation in an abnormal situation, for example, when power outages of the grid 3 are triggered. In addition, the energy storage system 1 may supply the power generated by the power generation system 2 or the power stored in the battery 40 to the load 4 when the grid 3 is in the normal state.

The energy storage system 1 includes a power converter 10, a DC link unit 20, inverters 30, a battery 40, a BMS (battery management system) 41, a converter 50, a grid connector 60, a power measuring unit 70, a power predicting unit 74, and a controller 80. The inverters 30 and the converter 50, for example, may be implemented as bi-directional inverters 30 and a bi-directional converter 50, respectively. The embodiment shown in FIG. 1 includes, for example, the bi-directional inverters 30 and the bi-directional converter 50.

Further, embodiments of the present invention may include a plurality of bi-directional inverters 31 to 33 connected in parallel, and a plurality of switches 91 to 93 located between respective ones of the bi-directional inverters 31 to 33 and the DC link unit 20. While, in the embodiment of FIG. 1, the bi-directional inverters are implemented by first to third bi-directional inverters 31, 32, 33, this is only representative of an embodiment of the present invention. Other embodiments of the present invention are not limited thereto.

The power converter 10 is connected between the power generation system 2 and a first node N1, and converts the power produced by the power generation system 2 into DC voltage of the first node N1. An operation of the power converter 10 varies according to the power generated by the power generation system 2. For example, when the power generation system 2 generates AC voltage, the power converter 10 converts the AC voltage into DC voltage of the first node N1. Further, when the power generation system 2 generates DC voltage, the power converter 10 may boost or reduce the DC voltage into DC voltage of the first node N1.

For example, when the power generation system 2 is a photovoltaic system, the power converter 10 may be an MPPT (maximum power point tracking) converter for detecting the maximum power point according to solar flux change by solar light or temperature change by solar heat, and for producing the power. In addition, the power converter 10 may use various types of converters or rectifiers.

The DC link unit 20 is connected between the first node N1 and the bi-directional inverters 30 to maintain a direct current link voltage Vlink of the first node N1 regularly. The voltage level of the first node N1 may be unstable due to, for example, an instantaneous voltage drop of the power generation system 2 or the grid, or a peak load generation at the load 4, or the like. However, the voltage of the first node N1 should be maintained regularly to stably operate the bi-directional inverters 30 and bi-directional converter 50. To this end, the DC link unit 20 may use capacitors such as, for example, aluminum electrolytic capacitors, high voltage polymer capacitors, high voltage and current MLCCs (multi layer ceramic capacitors), or the like.

The battery 40 receives and stores the power produced by the power generation system 2 or the power of the grid 3, and supplies the stored power to the load 4 or the grid 3. The battery 40 is configured to include at least one battery cell, and each battery cell may include a plurality of bare cells. The battery 40 may be implemented by various types of battery cells, for example, nickel-cadmium battery, lead storage battery, NiMH (nickel metal hydride) battery, lithium ion battery, lithium polymer battery, etc.

The configuration of the battery 40 (for example, the number and arrangement of battery cells and bare cells) may vary according to power capacity, design conditions, and the like required by the energy storage system 1. For example, when the power consumption of the load 4 is large, it is possible to provide a plurality of battery cells as the battery 40, and when the power consumption of the load 4 is small, it is possible to provide a single battery cell as the battery 40.

A BMS 41 is connected to the battery 40, and controls charging and discharging operations of the battery 40 according to the controller 80. The BMS 41 may perform an overcharge protection function, an overdischarge protection function, an overcurrent protection function, an overvoltage protection function, an overheat protection function, a cell balancing function, etc., to protect and manage the battery 40. To this end, the BMS 41 monitors voltage, current, temperature, the remaining power amount, lifespan, charging state, and the like, of the battery 40, and may transmit the relevant information to the controller 80. Although the BMS 41 and the battery 40 are shown as separate components in the embodiment of FIG. 1, in other embodiments, the BMS 41 is integrated with the battery 40.

The bi-directional converter 50 DC-DC converts the voltage of the power output from the battery 40 into the desired voltage level, that is, the direct current link voltage Vlink used by the bi-directional inverters 30. In addition, the bi-directional converter 50 DC-DC converts charging power introduced through the first node N1 into the voltage level used by the battery 40. Here, the charging power is, for example, the power produced by the energy generation system 2 or the power supplied through the bi-directional inverters 30 from the grid 3.

The bi-directional inverters 30 are power converters formed between the first node N1 and a second node N2 connected to the load 4 or the grid connector 60. The bi-directional inverters 30 convert and output the direct current link voltage Vlink output from the energy generation system 2 or the battery 40 into alternating current voltage of the grid 3. Further, the bi-directional inverters 30 rectify the alternating voltage of the grid 3, and convert and output the rectified alternating voltage into the direct current link voltage Vlink to store the power of the grid 3 in the battery 40. The bi-directional inverters 30 may include filters for removing harmonics from the alternating voltage output to the grid 3, and PLL (phase locked loop) circuits for synchronizing the phase of the alternating voltage output from the bi-directional inverters 30 with the phase of the alternating voltage of the grid 3 to suppress generation of reactive power. In addition, the bi-directional inverters 30 may perform functions such as voltage fluctuation range limits, power factor correction, DC component removal, transient phenomena protection, and the like.

In particular, embodiments of the present invention include a plurality of bi-directional inverters, such as bi-directional inverters 31 to 33, connected in parallel, and a corresponding plurality of switches 91 to 93 formed between respective ones of the bi-directional inverters 31 to 33 and the DC link unit 20. This is in contrast to an energy storage system that is configured with a single bi-directional inverter for limiting and outputting the current according to a maximum capacity, thereby lowering inverting efficiency when the power consumption of the load is small and increasing the amount of electricity used by the system devices.

Accordingly, embodiments of the present invention are implemented with a plurality of bi-directional inverters connected in parallel, rather than using a single bi-directional inverter. Each of these bi-directional inverter systems may be rated for significantly less capacity than the single bi-directional inverter, but together they have a combined capacity comparable to that of the single bi-directional inverter. In addition, embodiments of the present invention selectively drive the inverters (for example, bi-directional inverters 31, 32, 33) according to the power consumption or power requirement of the load 4 to use each selected inverter's output up to its maximum. This implements high efficiency by maximally using each selected inverter's output and reducing power consumption of the whole system by varying the power consumption of the system according to the load.

Here, each of the bi-directional inverters 31, 32, 33 and switches 91, 92, 93 are controlled by the controller 80. For the convenience of the description, hereinafter, the maximum power consumption of the load 4 will be set 3 kW. In addition, and for example, it will be assumed that there are three bi-directional inverters and corresponding switches, but the embodiments of the present invention are not limited thereto.

The grid connector 60 is connected between the power grid 3 and the bi-directional inverters 30. When the power grid 3 is in an abnormal situation, the grid connector 60 blocks connection of the energy storage system 1 and the power grid 3 under control of the controller 80. The grid connector 60 may be formed by switching devices such as a junction transistor (BJT), a field effect transistor (FET), etc.

Although not shown, switches may be further connected between the bidirectional inverters 30 and the load 4. In addition, a switch may be connected to the grid connector 60 in series, and blocks the power flowing into the load 4 under control of the controller 80. The switch is formed using, for example, a junction transistor (BJT), a field effect transistor (FET), etc.

The power measuring unit 70 measures the load amount, that is, the power consumption of the load 4. The power measuring unit 70 includes, for example, a voltage measuring unit 71 for measuring voltage applied to the load 4, and a current measuring unit 72 for measuring current to be supplied to the load 4. The power measuring unit 70 may calculate the power consumption of the load 4 by multiplying the measured voltage value and current value.

At this time, the measured voltage value and current value are transmitted to the controller 80. Instead of, or in addition to, these values, the load amount (that is, the power consumption of the load 4 as calculated by the power measuring unit 70) may be transmitted to the controller 80. That is, the calculation of the load amount of the load 4 may be performed in the power measuring unit 70 or the controller 80.

Further, a power predicting unit 74 that predicts the load amount or the load requirement, that is, the power consumption or the power requirement of the load 4, may also be included as a part of the energy storage system 1. The power predicting unit 74 may, for example, store power consumption data of the load 4 (for an example, the load power consumption data for the past year) as a lookup table, and may predict the power consumption or power requirement of the load 4 based on the power consumption data. When predicting energy demand, the power prediction unit may want to provide a cushion, for example, an extra 10% or 20% of the predicted value, to account for possible variations in load demands over the normally predicted amounts.

In FIG. 1, the power measuring unit 70 and the power predicting unit 74 are configured separately, but it is possible to integrate the power measuring unit 70 and the power predicting unit 74. For an example, a smart meter may implement operations of both of the power measuring unit and the power predicting unit.

To summarize, the energy storage system 1 of FIG. 1 is characterized by selectively driving the inverters 31, 32, 33 in accordance with the measured load amount of the load as measured by the power measuring unit 70, or with the estimated load amount of the load, that is, the power requirement of the load, as calculated by the power predicting unit 74.

The controller 80 monitors a state of the power generation system 2, the grid 3, the battery 40, and the load 4. The controller also controls, for example, the power converter 10, the DC link unit 20, the bi-directional inverters 30 (and their switches 91, 92, 93), the BMS 41, the bi-directional converter 50, and the grid connector 60 according to results of the monitoring. Further, the controller 80 receives the load amount of the load 4 as measured by the power measuring unit 70, or receives the voltage value and the current value of the load, and calculates the load amount of the load 4 by multiplying the voltage value and the current value. In addition, the controller 80 may receive the estimated load amount of the load 4 as calculated by the power measuring unit 70.

For example, in the embodiment of FIG. 1 and FIG. 2, the controller 80 includes a load information receiving unit 82 for receiving the voltage value and the current value of the load, or for receiving the power consumption or power requirement of the load 4. That is, the controller 80 may receive the value of the load amount as load information of the load 4 as measured by the power measuring unit 70, or receive the estimated load amount of the load 4 as calculated by the power predicting unit 74. The controller 80 also includes a switch controller 84 for controlling operation of the plurality of switches 91, 92, 93 connected to respective ones of the bi-directional inverters 31, 32, 33 to select at least one of the plurality of bi-directional inverters 31, 32, 33 provided in parallel based on the received load information.

Therefore, the controller 80 according to an embodiment of the present invention controls the operation of the plurality of first to third bi-directional inverters 31, 32, 33 connected in parallel according to the load information of the load 4, and controls the first to third switches 91, 92, 93 provided in correspondence to the bi-directional inverters 31, 32, 33 to selectively drive the bi-directional inverters 31, 32, 33.

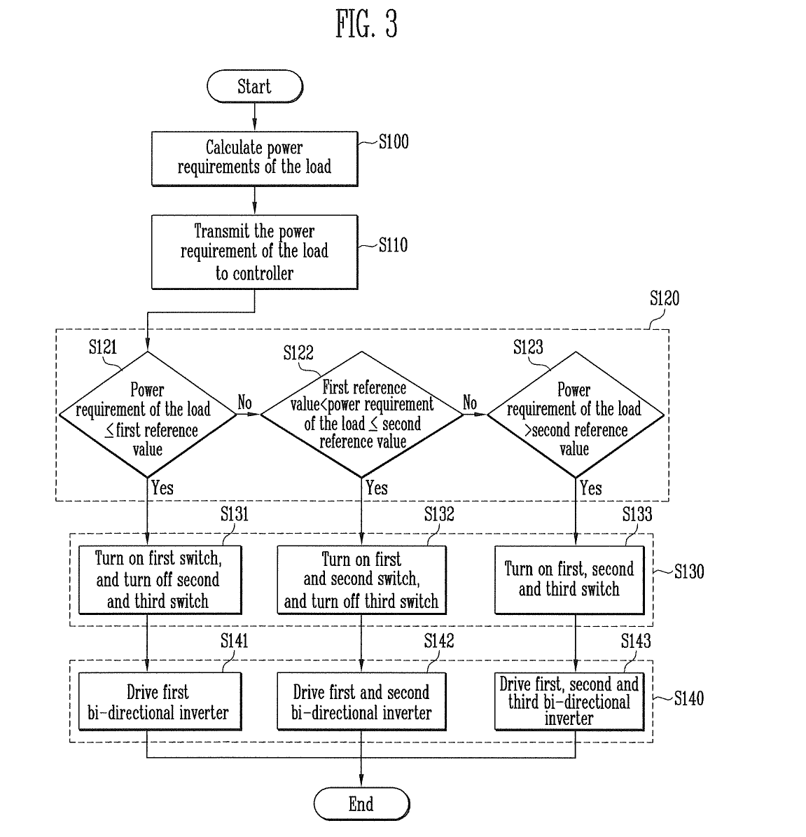

The plurality of bi-directional inverters 31, 32, 33 may have the same rated capacity, or may have different rated capacities from each other (for example, each inverter may have a different rated capacity, or some inverters may share one rated capacity while other inverters share a different rated capacity). First, the operations of the plurality of bi-directional inverters 30 that have the same rated capacity (for example, 1 kW) will be considered. A specific controlling method about these operations is described below with reference to FIG. 3.

As an example, if the power requirement of the load 4, that is, the measured load amount or the estimated load amount of the load, is below 1 kW, a switch, that is, the first switch 91, is turned on, and the second and third switches 92, 93 are turned off. That is, the first bi-directional inverter 31 connected to the first switch 91 is driven, and the second and third bi-directional inverters 32, 33 connected to the second and third switches 92, 93 are not operated. Further, if the power requirement of the load 4 is larger than 1 kW and smaller than 2 kW, two switches, that is, the first and second switches 91, 92, are turned on, and the third switch 93 is turned off. That is, the first and second bi-directional inverters 31, 32 connected to the first and second switches 91, 92 are driven, and the third bi-directional inverter 33 connected to the third switch 93 is not operated. Finally, if the power requirement of the load 4 is larger than 2 kW, all the switches, that is, the first, second, and third switches 91, 92, 93, are turned on, and the first, second, and third bi-directional inverters 31, 32, 33 connected thereto are driven.

High efficiency is thus achieved by maximally using the output of as few of the bi-directional inverters (each having a relatively small capacity) as needed, as compared to using a single (relatively high capacity) bi-directional inverter. That is, to overcome the efficiency reduction of a single inverter that is used significantly below its rated capacity, it is possible to use selected ones of a plurality of inverters that have lower rated capacities, and therefore, suffer less efficiency loss when driven by the same load as the single high capacity inverter.

Extending the above concept further, if the rated capacity of all the bi-directional inverters 31, 32, 33 is the same, for example, 1 kW in the above example, and if the power requirement of the load 4 is a little larger than 1 kW, or is smaller than 0.3 kW, there is a disadvantage in that the efficiency of the inverters are somewhat decreased. That is, in the first case, two inverters are needed with a combined capacity of 2 kW, but the load is only a little over half of that. In the second case, only a single inverter is needed, but it is only driven to less than 30% of its rated capacity.

Accordingly, in another embodiment of the present invention, such a disadvantage may be overcome by setting the rated capacities of the bi-directional inverters to be different from each other. That is, consider for an example, setting the rated capacity of the first bi-directional inverter 31 to 0.5 kW, setting the rated capacity of the second bi-directional inverter 32 to 1 kW, and setting the rated capacity of the third bi-directional inverter 33 to 2 kW. This combination of rated capacities allows for selectively driving the plurality of inverters in correspondence to the load amount of the load in a wide range and therefore, lessening or minimizing efficiency decline of the inverters. For instance, for loads a little larger than 1 kW, both the first and second bi-directional inverters 31, 32 can be driven, with a combined capacity of 1.5 kW as opposed to the 2 kW needed when all the inverters have the same rated capacity. Likewise, for loads smaller than 0.3 kW, only the first bi-directional inverter 31 is driven, whose 0.5 kW capacity is much smaller than the 1 kW capacity when all the inverters have the same capacity.

In more detail, if the power requirement of the load 4, that is, the measured load amount or the estimated load amount of the load, is below 0.5 kW, the first switch 91 turns on, and the second and third switches 92, 93 turn off. That is, the first bi-directional inverter 31 connected to the first switch 91 is driven, and the second and third bi-directional inverters 32, 33 connected to the second and third switches 92, 93 are not driven. Further, if the power requirement of the load 4 is above 0.5 kW and below 1 kW, the second switch 92 turns on, and the first and third switches 91, 93 turn off. That is, the second bi-directional inverter 32 connected to the second switch 92 is driven, and the first and third bi-directional inverters 31, 33 connected to the first and third switches 91, 93 are not driven.

In a similar fashion, if the power requirement of the load 4 is above 1 kW and below 1.5 kW, the first and second switches 91, 92 turn on, and the third switch 93 turns off. That is, the first and second bi-directional inverters 31, 32 connected to the first and second switches 91, 92 are driven, and the third bi-directional inverter 33 connected to the third switch 93 is not driven. Further, if the power requirement of the load 4 is above 1.5 kW and below 2 kW, the third switch 93 turns on, and the first and second switches 91, 92 turn off. That is, the third bi-directional inverter 33 connected to the third switch 93 is driven, and the first and second bi-directional inverters 31, 32 connected to the first and second switches 91, 92 are not driven.

Continuing with this approach, if the power requirement of the load 4 is above 2 kW and below 2.5 kW, the first and third switches 91, 93 turn on, and the second switch 92 turns off. That is, the first and third bi-directional inverters 31, 33 connected to the first and third switches 91, 93 are driven, and the second bi-directional inverter 32 connected to the second switch 92 is not driven.

Further, if the power requirement of the load 4 is above 2.5 kW and below 3 kW, the second and third switches 92, 93 turn on, and the first switch 91 turns off. That is, the second and third bi-directional inverters 31, 33 connected to the second and third switches 92, 93 are driven, and the first bi-directional inverter 31 connected to the first switch 91 is not driven. Finally, if the power requirement of the load 4 is above 3 kW, all switches, that is, the first, second, and third switches 91, 92, 93 turn on, and the first, second, and third bi-directional inverters 31, 32, 33 connected to the first, second, and third switches 91, 92, 93 are driven.

As described above, in embodiments of the present invention, the power consumption of the system may be varied according to the power requirement of the load. Accordingly, improvements in system power consumption can be achieved compared to systems employing a single high capacity inverter.

As an example, when considering the system power consumption in connection with system heat, P(heat)=I²(current)×R(resistance). That is, when current-amount doubles, the system heat value quadruples. Accordingly, when using a single inverter compared to when using three inverters, the difference in the current component is 9 times, that is, 3² times that of the system heat value. Thus, using the three lower capacity inverters leads to significantly less heat being generated. Therefore, when using the plurality of inverters like the above-described embodiments of the present invention, the heating value is reduced, such that the cost for heating reduction measures, for an example, providing a heat sink, may be reduced.

The controller 80 monitors the state of the power generation system 2, the grid 3, the battery 40, and the load 4, and also controls the BMS 41, the bi-directional inverters 30, the bi-directional converter 50, and the grid connector 60, but detailed descriptions for them are omitted for convenience of description.

FIG. 3 is a flow chart showing a controlling method of the energy storage system 1 of FIG. 1 according to an exemplary embodiment of the present invention wherein, for example, the rated capacities of the bi-directional inverters 31, 32, 33 are the same, such as 1 kW.

Referring to FIG. 1 to FIG. 3, first, the power measuring unit 70 measures voltage to be applied to the load 4 and current to be supplied to the load 4, or the power predicting unit 74 predicts the load amount, that is, the power consumption or power requirement of the load 4. Further, the power measuring unit 70 may calculate the load amount of the load 4 by multiplying each of the measured voltage value and current value. At this time, the measured voltage value and current value are transmitted to the controller 80, or the load amount of the load 4 is calculated, and the calculated value may be transmitted to the controller 80. That is, calculation of the load amount of the load 4 may be performed by the power measuring unit 70 or the controller 80. More completely stated, the load amount of the load 4 as measured by the power measuring unit 70, or the power requirement of the load 4, such as the estimated load amount of the load 4 as predicted by the power predicting unit 74, is calculated (S100).

Next, the power requirement of the calculated load is transmitted to the controller 80 (S110). That is, the controller 80 receives the load amount of the load 4 as measured by the power measuring unit 70 and/or information for the estimated load amount of the load 4 as predicted by the power predicting unit 74.

At this point, the controller 80 compares the power requirement of the load 4 with reference values (S120), and controls the operation of the plurality of first to third bi-directional inverters 31, 32, 33 connected in parallel based on the compared values. In addition, the first to third switches 91, 92, 93 provided in correspondence to respective ones of the bi-directional inverters (S130) are set by the controller to selectively drive the bi-directional inverters (S140).

The reference values are set to be smaller than the rated capacity of the bi-directional inverters. As an example, if the power requirement of the load 4 is below a first reference value (for example, 900 W) (S121), a switch, that is, the first switch 91, is turned on, and the second and third switches 92, 93 are turned off. That is, the first bi-directional inverter 31 connected to the first switch 91 is driven, and the second and third bi-directional inverters 32, 33 connected to the second and third switches 92, 93 are not operated (S141).

Further, if the power requirement of the load 4 is larger than the first reference value and smaller than the second reference value (for example, 1800 W) (S122), two switches, that is, the first and second switches 91, 92, are turned on, and the third switch 93 is turned off (S132). That is, the first and second bi-directional inverters 31, 32 connected to the first and second switches 91, 92 are driven, and the third bi-directional inverter 33 connected to the third switch 93 is not driven (S142).

Finally, if the power requirement of the load 4 is larger than the second reference value (S123), all the switches, that is, the first, second, and third switches 91, 92, 93 are turned on (S133), and the first, second, and third bi-directional inverters 31, 32, 33 connected thereto are driven (S143).

As described above, output of multiple bi-directional inverters each having small capacity, as compared with a single bi-directional inverter having a large capacity, may achieve high system efficiency, by allowing for varying the power consumption according to the load and therefore, reducing the system power consumption amount.

Embodiments of the present invention provide for a plurality of inverters and allow for selectively driving the plurality of inverters connected in parallel according to power requirements of the load, thereby implementing high efficiency by better using each rated output and reducing power consumption of the whole system by varying power consumption of the system according to the load.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An energy storage system for supplying an alternating current (AC) power to a load, the energy storage system comprising:
a battery for supplying a direct current (DC) power;
a plurality of inverters for connecting in parallel between the battery and the load to convert the DC power to the AC power; and
a controller for selectively driving the inverters in accordance with a power requirement of the load.

2. The energy storage system of claim 1, further comprising a corresponding plurality of switches between the inverters and the battery for switchably connecting respective ones of the inverters in parallel to the DC power, wherein the controller is configured to selectively control respective ones of the switches between the inverters and the battery in accordance with the power requirement of the load.

3. The energy storage system of claim 2, wherein the controller comprises:
a load information receiving unit for receiving information regarding the power requirement of the load; and
a switch controller for controlling the switches for selecting corresponding ones of the inverters in accordance with the received information.

4. The energy storage system of claim 3, wherein the controller is further configured to control a provision of operating power to the selected ones of the inverters.

5. The energy storage system of claim 1, further comprising a power measuring unit for
acquiring the power requirement of the load, and
supplying the acquired power requirement of the load to the controller.

6. The energy storage system of claim 1, further comprising a power predicting unit for predicting the power requirement of the load.

7. The energy storage system of claim 1, wherein the controller is configured to determine which of the inverters to selectively drive by:
comparing the power requirement of the load with one or more thresholds; and
determining a corresponding subset of the inverters to selectively drive in accordance with the comparing.

8. The energy storage system of claim 7, wherein exceeded ones of the one or more thresholds are smaller than a sum of rated capacities of the corresponding subset of the inverters.

9. The energy storage system of claim 1, wherein
the inverters have substantially a same rated capacity, and
the controller is configured to increase a number of the inverters that are selectively driven in accordance with an increase in the power requirement of the load.

10. The energy storage system of claim 9, wherein the controller is further configured to selectively drive a minimum number of the inverters that meets the power requirement of the load.

11. The energy storage system of claim 1, wherein
the inverters have different rated capacities, and
the controller is configured to selectively drive ones of the inverters having a lowest sum of respective rated capacities that meets the power requirement of the load.

12. The energy storage system of claim 1, wherein the inverters are bi-directional inverters for converting the AC power from an AC source to the DC power.

13. A method of controlling an energy storage system for supplying an alternating current (AC) power to a load, the energy storage system comprising a battery for supplying a direct current (DC) power and a plurality of inverters for connecting in parallel between the battery and the load to convert the DC power to the AC power, the method comprising:
selectively driving the inverters in accordance with a power requirement of the load.

14. The method of claim 13, wherein
the energy storage system further comprises a corresponding plurality of switches between the inverters and the battery for switchably connecting respective ones of the inverters in parallel to the DC power, and
the selectively driving of the inverters in accordance with the power requirement of the load comprises selectively controlling respective ones of the switches between the inverters and the battery in accordance with the power requirement of the load.

15. The method of claim 13, further comprising acquiring the power requirement of the load.

16. The method of claim 15, wherein the acquiring of the power requirement of the load comprises predicting the power requirement of the load.

17. The method of claim 13, wherein the selectively driving of the inverters in accordance with the power requirement of the load comprises:
comparing the power requirement of the load with one or more thresholds; and
determining which of the inverters to selectively drive in accordance with the comparing.

18. The method of claim 13, wherein
the inverters have substantially a same rated capacity, and
the selectively driving of the inverters in accordance with the power requirement of the load comprises increasing a number of inverters that are selectively driven in accordance with an increase in the power requirement of the load.

19. The method of claim 18, wherein the selectively driving of the inverters in accordance with the power requirement of the load further comprises selectively driving a minimum number of the inverters that meets the power requirement of the load.

20. The method of claim 13, wherein
the inverters have different rated capacities, and
the selectively driving of the inverters in accordance with the power requirement of the load comprises selectively driving ones of the inverters having a lowest sum of respective rated capacities that meets the power requirement of the load.
